(19) United States
(12) Patent Application Publication
(10) Pub. No.: US 2025/0269745 A1
(43) Pub. Date: Aug. 28, 2025

(54) POWER UNIT ROOM INSTALLING STRUCTURE

(71) Applicant: TOYOTA JIDOSHA KABUSHIKI KAISHA, Toyota-shi (JP)

(72) Inventor: Kozo Yamamoto, Nagoya-shi (JP)

(73) Assignee: TOYOTA JIDOSHA KABUSHIKI KAISHA, Toyota-shi (JP)

(21) Appl. No.: 18/975,418

(22) Filed: Dec. 10, 2024

(30) Foreign Application Priority Data
Feb. 28, 2024 (JP) 2024-029117

(51) Int. Cl. B60L 53/18; B60L 1/02; B60L 3/00

(52) U.S. Cl. CPC B60L 53/18; B60L 1/02; B60L 3/0046

(57) ABSTRACT

The power unit room installing structure includes: a power unit disposed opposite to the dash panel in the vehicle front-rear direction; a high voltage component disposed between the power unit and the dash panel; a charger disposed on the vehicle upper side of the power unit; a charging cable disposed from the charger toward the dash panel; and a regulating cable that is another cable different from the charging cable, wherein a part of the charging cable is covered from the vehicle upper side, thereby restricting movement of the charging cable toward the vehicle upper side and allowing movement toward at least the dash panel side.

### CROSS-REFERENCE TO RELATED APPLICATION

This application claims priority to Japanese Patent Application No. 2024-029117 filed on Feb. 28, 2024, incorporated herein by reference in its entirety.

### BACKGROUND

### 1. Technical Field

The disclosure relates to a power unit room installing structure.

### 2. Description of Related Art

A hybrid electric vehicle in which a charging cable, for supplying electric power from an external power source to a battery (charger) provided at a rear portion of a vehicle, is installed in a power unit room of the vehicle, has been conventionally known (e.g., see Japanese Unexamined Patent Application Publication No. 2010-241291 (JP 2010-241291 A)).

### SUMMARY

However, in plug-in hybrid electric vehicles (PHEVs) and battery electric vehicles (EVs), which are chargeable, there are many components installed in the power unit room, and accordingly providing an empty space in the power unit room is difficult. Thus, it is desirable to provide means for suppressing occurrence of a secondary accident such as electric shock or the like, in preparation for when a high voltage component in the power unit room is damaged due to damage in the event of a collision.

Accordingly, an object of the disclosure is to provide a power unit room installing structure that is capable of suppressing occurrence of a secondary accident, in preparation for damage to a high voltage component in the power unit room, in the event of a collision.

A power unit room installing structure according to a first aspect of the disclosure includes
a power unit that is installed in a power unit room of a vehicle, and that is disposed facing a dash panel separating the power unit room and a vehicle cabin in a vehicle front-rear direction,
a high voltage component that is disposed between the power unit and the dash panel,
a charger that is disposed on a vehicle upward side from the power unit,
a charging cable that is routed from the charger toward the dash panel, and
a regulating cable that is another cable different from the charging cable, and that is configured to, by covering a portion of the charging cable from the vehicle upward side, regulate movement of the charging cable toward the vehicle upward side, and allow movement of the charging cable toward at least the dash panel side.

In the power unit room installing structure according to the first aspect of the disclosure, the high voltage component is disposed between the power unit and the dash panel. The charging cable extending from the charger disposed on the vehicle upward side from the power unit is routed toward the dash panel. Also, the regulating cable covering the charging cable is disposed in the power unit room. The regulating cable is configured to regulate movement of the charging cable toward the vehicle upward side by covering part of the charging cable from the vehicle upward side, and allow movement of the charging cable toward at least the dash panel side.

Now, when the charging cable moves is when the vehicle is in a collision, for example. That is to say, when a collision load is input to the power unit room in the event of a collision of the vehicle, the charging cable moves together with the power unit and the charger in the power unit room. At this time, the charging cable is allowed to move toward the dash panel side by the restriction of the regulating cable, and accordingly moves between the power unit and the dash panel, whereby the high voltage component can be covered from the vehicle upward side. Thus, even when the high voltage component is damaged due to damage in the event of a collision, covering the high voltage component with the charging cable keeps a person who opens the power unit room from easily coming into contact with the high voltage component, and accordingly occurrence of a secondary accident such as electric shock or the like is suppressed.

With the power unit room installing structure according to a second aspect of the disclosure,
in the first aspect, the regulating cable is configured to allow movement of the charging cable toward the dash panel side such that the charging cable overlaps a live part of the high voltage component in plan view.

In the power unit room installing structure according to the second aspect of the disclosure, the charging cable is allowed to move so as to overlap the live part of the high voltage component by the regulating cable. Accordingly, a person who opens the power unit room can be effectively suppressed from coming into contact with the live part regarding which there is a high risk of electric shock.

With the power unit room installing structure of the third aspect according to the disclosure, in the first aspect or the second aspect,
the regulating cable is a cable in which an extra length of the cable is set to be shorter than an extra length of the charging cable.

In the power unit room installing structure according to the third aspect of the disclosure, the regulating cable is a cable in which an extra length of the cable is set to be shorter than an extra length of the charging cable, and accordingly the movement of the charging cable to the vehicle upper side can be readily regulated.

With the power unit room installing structure according to a fourth aspect of the disclosure, in any one aspect of the first aspect to the third aspect, the regulating cable is a cable that connects a transaxle included in the power unit, and the charger.

In the power unit room installing structure according to the fourth aspect of the disclosure,
the cable connecting the transaxle and the charger is used as the regulating cable.

The cable connecting the transaxle and the charger is usually made up of a high voltage harness, and accordingly the cable has a relatively large cross-sectional area, and is excellent with regard to a protective function of protecting electric wires from external damage. Accordingly, the charging cable can be appropriately regulated even in the event of a collision of the vehicle.

With the power unit room installing structure according to a fifth aspect of the disclosure, in any one aspect of the first to fourth aspects,
the vehicle is a plug-in hybrid electric vehicle (PHEV) equipped with the power unit that includes an engine and a transaxle,
in the power unit room, the engine and the transaxle are arrayed side by side in a vehicle width direction,
the high voltage component is disposed between the engine and the dash panel,
the charger is installed on the vehicle upward side from the transaxle, and also side by side with the engine in the vehicle width direction in plan view,
the charging cable is routed so as to pass through a space between the engine and the charger and head toward the dash panel, and
the regulating cable is configured to, by covering a portion of the charging cable from the vehicle upward side, regulate movement of the charging cable toward the vehicle upward side, and allow movement of the charging cable toward the dash panel side and also the high voltage component side.

In the power unit room installing structure according to the fifth aspect of the disclosure, the high voltage component is disposed between the engine and the dash panel, the transaxle is disposed side by side in the vehicle width direction with the engine, and the charger is disposed on the vehicle upward side of the transaxle. Thus, even in PHEVs having many components installed in the power unit room, routing the charging cable extending from the charger through the space between the engine and the charger enables the extra length of the charging cable to be efficiently secured. Further, causing the extra length of the charging cable to move to the dash panel side and also the high voltage component side by regulating by the regulating cable enables the high voltage component to be covered from the vehicle upward side. Thus, occurrence of a secondary accident such as electric shock or the like can be suppressed, while efficiently securing extra length of the charging cable.

As described above, according to the disclosure, occurrence of a secondary accident can be suppressed in preparation for damage of a high voltage component in the power unit room in the event of a collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view schematically showing a power unit room installing structure according to the present embodiment;

FIG. 2 is an enlarged schematic plan view of the power unit room installing structure according to the present embodiment;

FIG. 3 is an enlarged schematic side view of the power unit room installing structure according to the present embodiment;

FIG. 4 is a schematic plan view showing an enlarged view of a power unit room installing structure according to the present embodiment in which barriers collide with each other from the front side of the vehicle; and

FIG. 5 is a schematic plan view illustrating an enlarged state in which an area collides with a power unit room installing structure as a comparative example from a vehicle front side.

### DETAILED DESCRIPTION OF EMBODIMENTS

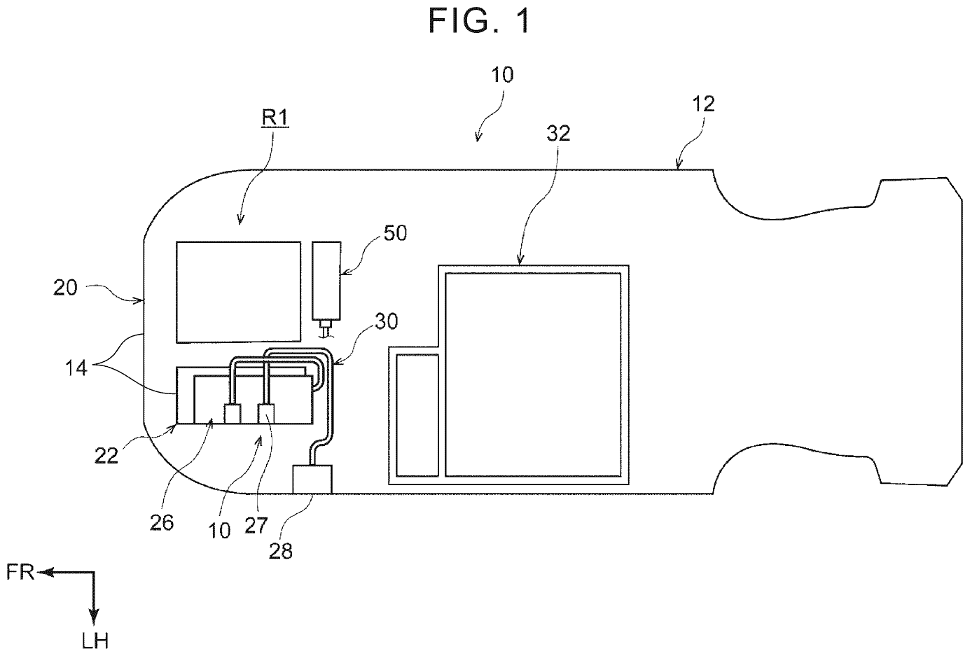

Hereinafter, an embodiment according to the disclosure will be described with reference to FIGS. 1 to 4. For convenience of explanation, an arrow UP shown in the drawings is defined as a vehicle upward direction, an arrow FR is defined as a vehicle forward direction, and an arrow LH is defined as a vehicle leftward direction. Thus, when terms indicating directions, i.e., upward and downward, forward and rearward, and right and left are used in the following description without any specification, these mean upward and downward of the vehicle, forward and rearward of the vehicle, and right and left of the vehicle. Further, the right-left direction is synonymous with a vehicle width direction.

### Overall Configuration of the Power Unit Room

As illustrated in FIGS. 1 to 4, the power unit room installing structure 10 according to the present embodiment is mounted on the front portion of the vehicle 12. A power unit room R1 is provided at a front portion of the vehicle 12, and a power unit 14 as a group of devices for generating power during traveling of the vehicle 12 is mounted. The power unit 14 is disposed to face the dash panel 18 that separates the power unit room R1 and the vehicle cabin in the vehicle front-rear direction.

Note that, for example, the vehicle 12 is constituted by a chargeable plug-in hybrid electric vehicle (PHEV vehicle). Therefore, the power unit 14 includes an engine 20 as an internal combustion engine and a transaxle 22. The transaxle 22 has a configuration in which, for example, a motor (not shown) as a drive source, an inverter (not shown) that controls electric power supplied to the motor, and a transmission (not shown) that appropriately decelerates the rotation of the motor and transmits it to the drive wheels are integrated.

In the power unit room R1, the engine 20 and the transaxle 22 are mounted side by side in a plan view. A charger 26 is mounted on the upper side of the transaxle 22. The charger 26 is mounted on the upper side of the transaxle 22 and side by side in the vehicle width direction with respect to the engine 20 in a plan view. Furthermore, a charging cable 30 is arranged from the charger 26 towards the dash panel 18. The tip of the charging cable 30 is routed to a charging port 28 for external power connection provided on the outer plate of the vehicle 12.

For example, in the case of the vehicle 12 having the right steering wheel, the charging port 28 is provided at an upper portion of a left front fender (not shown) as an outer plate thereof. A battery 32 (see FIG. 1) charged through the charger 26 is mounted at a substantially central portion of the vehicle 12 in the front-rear direction.

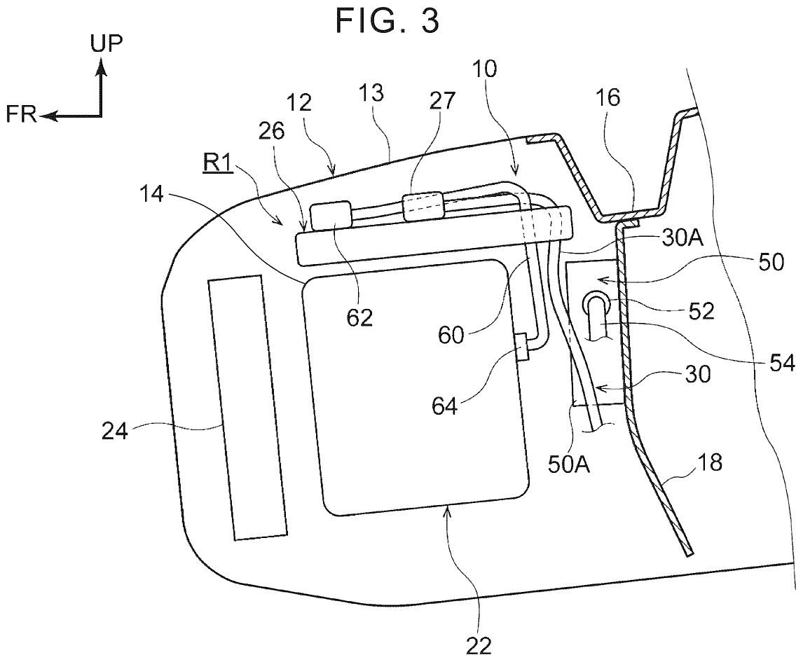

The charger 26 is formed in a substantially rectangular box shape having a predetermined thickness (low height) (see FIG. 3). The charger 26 is fixed to the upper surface of the transaxle 22 via a support member (not shown) in such a manner that its longitudinal direction is in a posture along the front-rear direction. In addition, the transaxle 22 according to the present embodiment is disposed on the left side of the engine 20 in the power unit room R1.

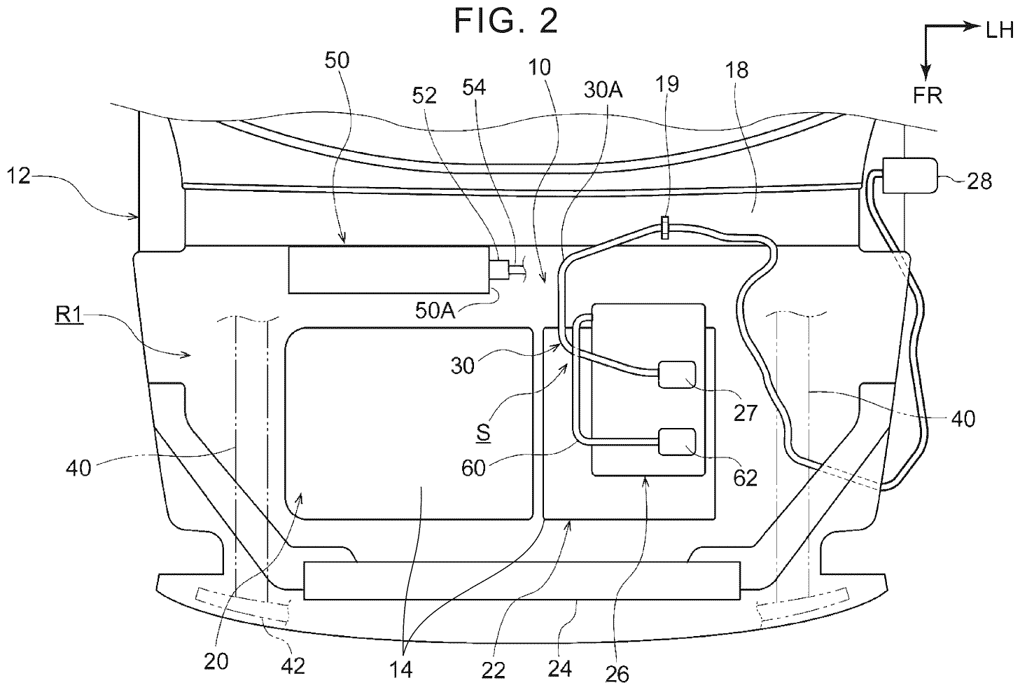

Further, in the power unit room R1, a radiator 24 (see FIGS. 2 and 3) and a cooling device (not shown) for cooling the charger 26 are disposed on the front side (the front end in the power unit room R1) of the engine 20 and the transaxle 22 (the charger 26). The cooling device and the charger 26 are connected by a pipe (not shown) through which the refrigerant passes.

Here, the engine 20 and the transaxle 22 are supported by a pair of left and right front side members 40 via a mount (not shown). The front end portion of the front side member 40 is connected to the bumper reinforcement 42 extending in the vehicle width direction. The engine 20 and the transaxle 22 may be supported by a suspension member (not shown) attached to the lower surface of the front side member 40 via a mount.

Further, in the power unit room R1, a cowl 16 (see FIG. 3 and omitted in FIG. 2) extending in the vehicle-width direction is disposed on the rear side of the engine 20 and the charger 26 (the rear end in the power unit room R1) in a plan view. The power unit room R1 is covered from above by a substantially flat plate-shaped hood 13 (see FIG. 3). That is, the hood 13 extending in the front-rear direction and the vehicle width direction is arranged above the engine 20 and the charger 26.

### High Voltage Component

As shown in FIG. 2, a high voltage component 50 is disposed between the power unit 14 and the dash panel 18. Here, for example, the high voltage component 50 is a water heater (so-called PTC heater) that functions as a heat source for warming the battery 32. The high voltage component 50 heats the water instead of the engine waste heat, and circulates the hot water by a water pump (not shown) to warm the battery 32 mounted on the lower side of the floor of the vehicle cabin. Thus, in use in a cold district or the like, it is possible to prevent the battery 32 from being cooled down and shorten the charging time. The high voltage component 50 may be a water heater that functions as a heat source for heating the vehicle cabin.

Since the high voltage component 50 represented by the above-described water heater or the like is a high-voltage heater, it contributes to enhancing the safety of the occupant in the vehicle cabin by disposing the high-voltage heater between the power unit 14 and the dash panel 18, that is, outside the vehicle cabin.

In the present embodiment, the high voltage component 50 is formed in a substantially rectangular box shape having a small thickness (low height) in the vehicle front-rear direction (see FIGS. 2 and 3). The high voltage component 50 has a posture in which the longitudinal direction thereof is along the vehicle width direction, and is fixed to a substantially central portion of the dash panel 18 in the vehicle vertical direction via a support member (not shown). In addition, the high voltage component 50 according to the present embodiment is disposed on the rear side of the engine 20 in the power unit room R1. In the present embodiment, the high voltage component 50 is provided with a live part 52 in which a high-voltage harness 54 is connected to a side surface 50A (a left side surface in FIG. 2) disposed facing the transaxle 22.

### Charging Cable

Further, as shown in FIG. 2, a space S (a gap that is a dead space) is formed between the upper portion of the engine 20 and the charger 26 (a portion opposed in the vehicle width direction) in a plan view, which is longer in the front-rear direction and wider in width (length along the vehicle width direction) than the outer diameter of the charging cable 30. The charging cable 30 in the present embodiment is routed through the space S.

Specifically, a connector 27 is provided at one end of the charging cable 30, the other end of which is connected to the charging port 28. The connector 27 is connected to, for example, a portion of the upper surface of the charger 26 that is substantially in the center in the front-rear direction and that is away from the engine 20. The charging cable 30 is routed to the rear side toward the dash panel 18 from the side facing the engine 20 of the charger 26 in the vehicle width direction.

That is, the charging cable 30 is drawn out from the connector 27 to the engine 20 side along the vehicle width direction, and then bent rearward so as to pass through the space S, and is wired. Then, the charging cable 30 arranged through the space S to the rear side is bent downward on the front side of the cowl 16, and the front is arranged along the dash panel 18.

In this way, the charging cable 30 can be said to be in a state in which the portion drawn out from the connector 27 is arranged to the dash panel 18 side through the space S without passing through the upper surface of the charger 26, so as to have a certain margin. Here, the deflection of the charging cable 30 (the extra-long portion 30A) means that, for example, a substantially arc-shaped loop-shape is formed (see FIG. 3). Then, the intermediate portion of the charging cable 30 bent downward from the bent portion of the charging cable 30 (hereinafter sometimes referred to as “extra-long portion 30A”) is fixed by a fixing metal fitting 19 (see FIG. 2) such as a clamp to the dash panel 18.

### Regulating Cable

Here, as shown in FIGS. 2 and 3, at a position overlapping at least a part of the power unit 14 in a plan view, a part of the charging cable 30 is covered from the upper side by the regulating cable 60.

Specifically, the regulating cable 60 is, for example, a cable that connects an inverter (not shown) included in the transaxle 22 and the charger 26. The regulating cable 60 is also referred to as a PN cable because each of the positive and negative electrodes of the battery 32 is connected to an inverter. The regulating cable 60 is composed of a high-voltage harness. The regulating cable 60 includes a shield layer for preventing electromagnetic noise from being affected by the surrounding electronic devices and signal lines, and a resin or metal exterior material provided for protecting the electric wires, and therefore has a relatively large cross-sectional area and is excellent in a protective function of protecting the electric wires from trauma.

A first PN connector (Positive Negative Connector) 62 is provided at one end of the regulating cable 60, and the first PN connector 62 is connected to, for example, a front portion of the connector 27 on the upper surface of the charger 26. Further, the other end of the regulating cable 60, a second PN connector 64 is provided, the second PN connector 64, for example, is connected to the vehicle-vertical substantially central portion of the rear surface of the transaxle 22 (the surface facing the dash panel 18). The first PN connector 62 and the second PN connector 64 are two-pole high-voltage connectors corresponding to the positive electrode and the negative electrode.

The regulating cable 60 is routed to the rear side toward the dash panel 18 from the side facing the engine 20 of the charger 26 in the vehicle width direction. The middle portion arranged toward the dash panel 18 passes through the space S and covers the extra-long portion 30A drawn out from the connector 27 of the charging cable 30 from above. The regulating cable 60 is connected to the rear surface of the transaxle by being bent downward by being pulled out from the space S ahead of the portion covering the charging cable 30.

In the arranged state as described above, the regulating cable 60 has a relatively short line length, and is in a state of hardly bending. In other words, in the regulating cable 60, the extra length of the cable is set to be shorter than the extra length of the charging cable 30. Therefore, the regulating cable 60 regulates the upward movement of the charging cable 30.

Further, in the charging cable 30, the extra-long portion 30A that does not overlap with the regulating cable 60 is bent in a substantially arc-shaped loop-shape protruding toward the engine-20 side and the dash panel 18 side in a plan view. Therefore, the regulating cable 60 allows the charging cable 30 to move toward the engine 20 side and toward the dash panel 18 side. Therefore, when the charging cable 30 moves during a front collision of the vehicle, the high voltage component 50 can be covered from above the vehicle by the extra-long portion 30A of the charging cable 30.

### Action and Effect

As described above, in the power unit room installing structure 10 according to the present embodiment, the high voltage component 50 is disposed between the power unit 14 and the dash panel 18. Further, a charging cable 30 extending from the charger 26 disposed on the vehicle upper side of the power unit 14 is arranged toward the dash panel 18. In addition, a regulating cable 60 that covers the charging cable 30 is disposed in the power unit room R1. The regulating cable 60 is configured to regulate movement of the charging cable 30 toward the vehicle upper side by covering a portion of the charging cable 30 from the vehicle upper side, and allow movement to at least the dash panel 18 side.

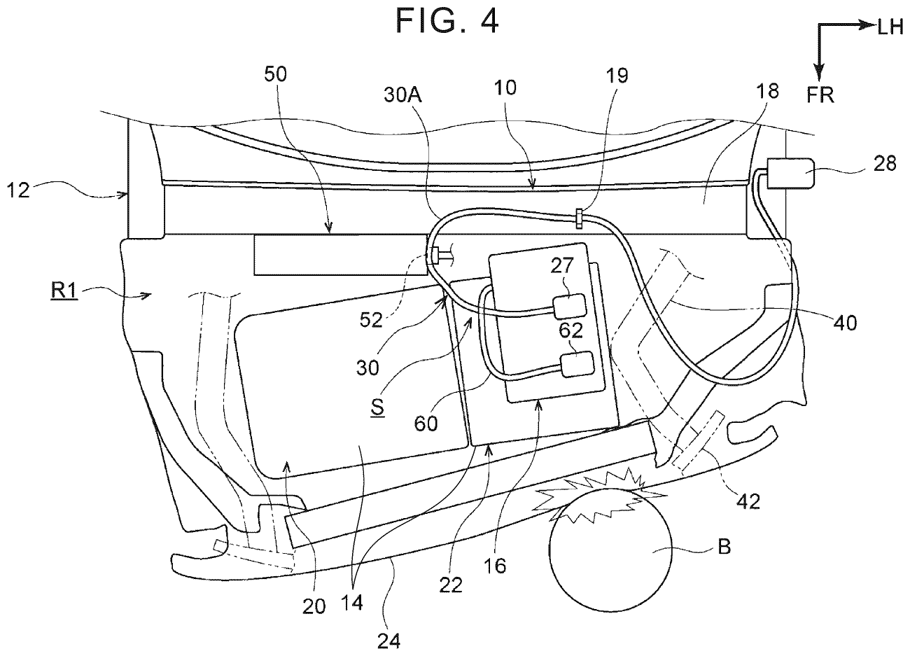

Here, as an example of the movement of the charging cable 30, a case where the barrier B collides with the power unit room installing structure 10 according to the present embodiment from the vehicle front side will be described with reference to FIG. 4. Note that FIG. 4 shows a state in which a collision load is input in a so-called offset collision in which a left portion (about ½ of the vehicle width) collides with the barrier B in a state of being wrapped with respect to the center in the vehicle width direction.

As shown in FIG. 4, when a collision load is inputted to the power unit room R1, the collision load is transmitted from the bumper reinforcement 42 to the front side member 40. When the collision load is transmitted to the front side member 40, the fragile portion (crushable zone) provided at the front end portion of the front side member 40 is compressively plastically deformed to absorb the collision load. Thereafter, by further input of the collision load, the front end portion of the front side member 40 is bent and deformed inward in the vehicle width direction starting from the fragile portion, and abuts against the front end portion of the power unit 14 (transaxle 22) and the end portion outside in the vehicle width direction. Accordingly, a collision load obliquely rearward toward the vehicle rear side and the anti-collision side (the vehicle width direction inner side) is input to the transaxle 22. As a result, the transaxle 22 and the charger 26 disposed on the upper side of the transaxle 22 move obliquely rearward toward the vehicle rear side and the anti-collision side (the vehicle width direction inner side).

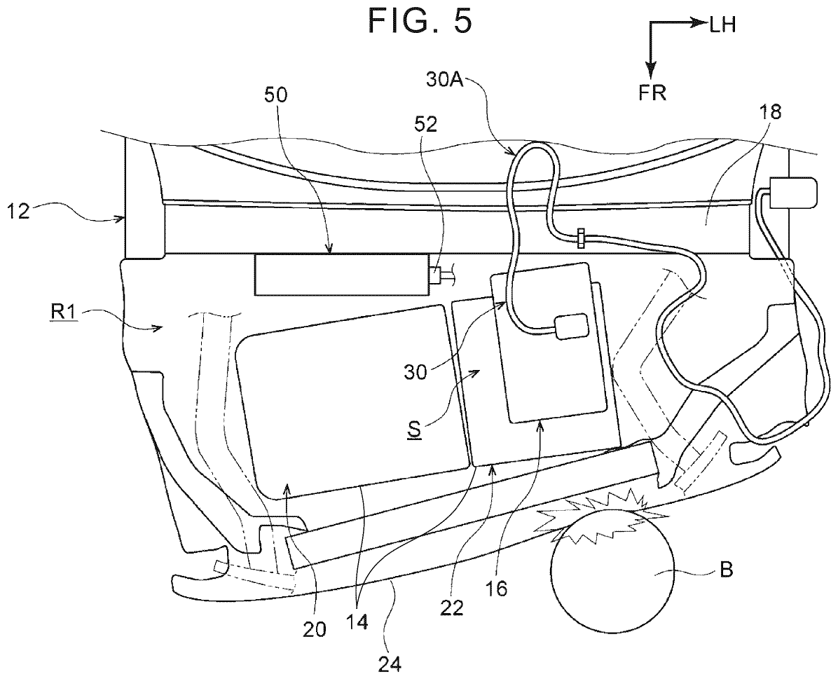

Here, as a comparative example, for example, as shown in FIG. 5, a part of the charging cable 30 may not be covered with the regulating cable 60. In this case, the extra-long portion 30A of the charging cable 30 moves toward the vehicle upper side, and has a substantially arcuate loop-shaped behavior that protrudes toward the vehicle upper side and bends. Therefore, the vehicle upper side of the high voltage component 50 becomes an open space, and contact with the high voltage component 50 is facilitated.

On the other hand, in the present embodiment, the extra-long portion 30A of the charging cable 30 is allowed to move toward the engine-20 side and the dash panel 18 side by the restriction of the regulating cable 60. Therefore, it moves between the power unit and the dash panel 18 to cover the high voltage component 50 from the vehicle upper side. Thus, even when the high voltage component 50 is damaged due to damage at the time of collision, the charging cable 30 is covered from the upper side. As a result, a person who opens the power unit room R1 cannot easily touch the high voltage component 50, and thus the generation of a secondary accident such as an electric shock is suppressed.

Further, as shown in FIG. 4, in the present embodiment, the extra-long portion 30A of the charging cable 30 is allowed to move so as to overlap with the live part 52 of the high voltage component 50. Therefore, it is possible to effectively suppress a person who opens the power unit room R1 from contacting the live part 52 having a higher risk of electric shock.

In FIG. 4, the offset collision of the left portion of the vehicle 12 has been described as an example. Similar effects can be obtained by moving the charging cable 30 toward the dash panel 18 in the case of an offset collision of a portion on the right side of the vehicle 12 or a so-called full-lap collision.

Further, in the present embodiment, the regulating cable 60, the extra length of the cable, since the cable is set to be shorter than the extra length of the charging cable 30, it is possible to easily restrict the movement of the charging cable to the vehicle upper side. Further, as compared with the case of restricting the moving of the charging cable using a fixed bracket such as clamping, since it does not require additional components, with reducing the number of components in the power unit room R1, it is possible to suppress the weight increment.

Further, in the present embodiment, a cable connecting the transaxle 22 and the charger 26 is used as the regulating cable 60. The cable connecting the transaxle 22 and the charger 26 is usually composed of a high-voltage harness, and therefore has a relatively large cross-sectional area and is excellent in a protective function of protecting the electric wire from trauma. Therefore, it is possible to appropriately regulate the charging cable 30 even when the vehicle 12 collides.

Further, in the present embodiment, the vehicle 12 is a PHEV vehicle, and the high voltage component 50 is disposed between the engine 20 and the dash panel 18. Further, the transaxle 22 is arranged side by side in the vehicle width direction with the engine 20, and the charger 26 is arranged on the vehicle upper side of the transaxle 22. In this way, even in PHEV vehicles having many components mounted in the power unit room, the charging cable 30 extending from the charger 26 is arranged through the space S between the engine 20 and the charger 26. This makes it possible to efficiently secure 30A of the extra-long portion of the charging cable 30. Then, by regulating the regulating cable 60 to move the extra length of the charging cable 30 to the dash panel 18 side and the high voltage component 50 side, it is possible to cover the high voltage component from the vehicle upper side. In this way, in the power unit room installing structure 10 according to the present embodiment, it is possible to efficiently secure 30A of the extra length portion of the charging cable 30, and to suppress the generation of a secondary accident such as an electric shock.

The power unit room installing structure 10 according to the present embodiment has been described above. The power unit room installing structure according to the disclosure is not limited to the illustrated one, and can be appropriately changed in design without departing from the gist of the disclosure.

For example, in the above-described embodiment, the power unit room installing structure 10 is configured to be applied to the front portion of the vehicle, but may be applied to the rear portion of the vehicle.

Further, in the above embodiment, the power unit room installing structure 10 is applied to PHEV vehicles, but the power unit room installing structure 10 may be applied to a battery electric vehicle (EV vehicle). In this case, the power unit may be constituted by a transaxle in which a motor as a drive source, an inverter that controls electric power supplied to the motor, and a transmission that appropriately decelerates the rotation of the motor and transmits the rotation to the drive wheels are integrated.

What is claimed is:

1. A power unit room installing structure, comprising:
a power unit that is installed in a power unit room of a vehicle, and that is disposed facing a dash panel separating the power unit room and a vehicle cabin in a vehicle front-rear direction;
a high voltage component that is disposed between the power unit and the dash panel;
a charger that is disposed on a vehicle upward side from the power unit;
a charging cable that is routed from the charger toward the dash panel; and
a regulating cable that is another cable different from the charging cable, and that is configured to, by covering a portion of the charging cable from the vehicle upward side, regulate movement of the charging cable toward the vehicle upward side, and allow movement of the charging cable toward at least the dash panel side.

2. The power unit room installing structure according to claim 1, wherein the regulating cable is configured to allow movement of the charging cable toward the dash panel side such that the charging cable overlaps a live part of the high voltage component in plan view.

3. The power unit room installing structure according to claim 1, wherein the regulating cable is a cable in which an extra length of the cable is set to be shorter than an extra length of the charging cable.

4. The power unit room installing structure according to claim 1, wherein the regulating cable is a cable that connects a transaxle included in the power unit, and the charger.

5. The power unit room installing structure according to claim 1, wherein:
the vehicle is a plug-in hybrid electric vehicle (PHEV) equipped with the power unit that includes an engine and a transaxle;
in the power unit room, the engine and the transaxle are arrayed side by side in a vehicle width direction;
the high voltage component is disposed between the engine and the dash panel;
the charger is installed on the vehicle upward side from the transaxle, and also side by side with the engine in the vehicle width direction in plan view;
the charging cable is routed so as to pass through a space between the engine and the charger and head toward the dash panel; and
the regulating cable is configured to, by covering a portion of the charging cable from the vehicle upward side, regulate movement of the charging cable toward the vehicle upward side, and allow movement of the charging cable toward the dash panel side and also the high voltage component side.
